(19) United States
(12) Patent Application Publication
(10) Pub. No.: US 2006/0240919 A1
(43) Pub. Date: Oct. 26, 2006

(54) Bicycle transmission

(75) Inventors: Shinya Matsumoto, Saitama (JP); Akio Senda, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/403,967

(22) Filed: Apr. 14, 2006

(30) Foreign Application Priority Data
Apr. 15, 2005 (JP) 2005-118931

(51) Int. Cl. F16H 59/00; F16H 61/00

(52) U.S. Cl. 474/78; 474/80

(57) ABSTRACT

To improve the operating performance of a chain. A bicycle transmission includes an alignment guide located between a drive sprocket and a transmission sprocket cluster for aligning a stagnant chain. The alignment guide consists of a guide roller having an outer circumferential surface for guiding the stagnant part of the chain in a way to align it. The outer circumferential surface has, in the axial direction, a large diameter portion on the side of a transmission sprocket with the smallest outside diameter, and a small diameter portion on the side of a transmission sprocket with the largest outside diameter, which is smaller in diameter than the large diameter portion. While the chain is not stagnant, the chain, wound around a transmission sprocket, contacts the small diameter portion.

### CROSS-REFERENCE TO RELATED APPLICATIONS

The present application claims priority under 35 USC 119 to Japanese Patent Application No. 2005-118931 filed on Apr. 15, 2005 the entire contents of which are hereby incorporated by reference.

### FIELD OF THE INVENTION

The present invention relates to a bicycle transmission which changes the speed by shifting a chain among plural transmission sprockets.

### DESCRIPTION OF BACKGROUND ART

AN example of a bicycle transmission that changes the speed by shifting a chain among plural transmission sprockets is disclosed in JP-A No. 155280/2004 which includes a drive sprocket connected through a one-way clutch to a crankshaft disposed between body frames with a plurality of transmission sprockets connected to an output shaft for driving a rear wheel. A chain is wound around the drive sprocket and a transmission sprocket. A gear shift mechanism has a derailleur arm which rotatably supports a guide pulley for guiding the chain to a transmission sprocket so that a gear change operation moves the derailleur arm together with the guide pulley in the axial direction of the derailleur to shift the chain from one transmission sprocket to another.

The chain around which the drive sprocket and transmission sprocket are wound may be prevented from operating smoothly due to the rotating condition of the drive sprocket and transmission sprocket based on the bicycle operating condition or the axial movement of the guide pulley induced by the gear shift mechanism. This phenomenon often happens when the transmission is located between the front wheel and the rear wheel, namely in the center of the body and close to the drive sprocket and transmission sprocket.

For example, as far as the chain on the drive sprocket wind-in side is concerned, it may happen that when the drive sprocket is driven by the crankshaft, it is tight, but when the transmission sprocket is driven by the drive wheel as while the bicycle is freewheeling, its tension decreases and it becomes loose and partially gets folded and stagnant in the drive sprocket wind-in portion, thus preventing smooth operation of the chain.

Also, when the transmission sprocket is rotating in the reverse direction during a backward movement of the bicycle or it is stopped while the bicycle is stationary, namely the transmission sprocket is not rotating normally, if a gear shift operation is carried out and the guide pulley moves axially, a considerable torsion occurs on the chain between the transmission sprocket and the guide pulley because the transmission sprocket does not move axially, causing a rapid rise in friction between neighboring links. This friction prevents the chain from sagging along the profile of the guide pulley. Consequently the chain will come off the guide pulley outward in its radial direction so that the chain cannot operate smoothly.

In addition, regarding a tension pulley which has teeth to engage with the chain, when it moves axially together with the guide pulley upon gear shift operation, a chain torsion may occur on its wind-in side. Since the chain's axial movement is limited by the tension pulley's teeth, this torsion, which occurs in a limited space in the circumferential direction of the tension pulley, becomes large, which increases the friction between neighboring links and thus prevents the chain from sagging along the profile of the tension pulley. As a result, a smooth chain operation and a smooth gear shift will be prevented.

### SUMMARY AND OBJECTS OF THE INVENTION

The present invention has been made in view of the above circumstances and an embodiment of the present invention is intended to improve the operating performance of the chain and an embodiment of the present invention is intended to improve the operability of the transmission.

According to an embodiment of the present invention, a bicycle transmission includes a drive sprocket which is rotated by a crankshaft with a transmission sprocket cluster which is disposed in the axial direction and composed of a plurality of transmission sprockets with different outside diameters. A chain is wound around the drive sprocket and the transmission sprockets with a shift mechanism for shifting the chain among the transmission sprocket cluster as described in gear shift operation. An alignment guide is located between the drive sprocket and the transmission sprocket cluster to align a stagnant part of the chain. The alignment guide consists of a guide part with a guide surface which guides the stagnant part of the chain in a way to align it. The guide surface, in the axial direction, is provided with a basic portion located on the side of the transmission sprocket with the smallest outside diameter, and a retreated portion which is located on the side of the transmission sprocket with the largest outside diameter and more retreated inside or outside the chain than the basic portion. The chain contacts the retreated portion while the chain is not stagnant.

According to an embodiment of the present invention, the stagnant part of the chain is guided by the guide part of the alignment guide to reach the alignment hole as aligned, resulting in resolution of the stagnancy, which prevents the stagnant part from being caught in the drive sprocket without resolving the stagnancy. In addition, since the chain, which contacts the guide part while it is not stagnant, contacts the retreated portion of the guide part and therefore the chain curves less than when it contacts the guide surface without a retreated portion. Thus, the friction applied from the guide part to the chain is reduced.

According to an embodiment of the present invention, the guide part is a guide roller having an outer circumferential surface which constitutes the guide surface with the retreated portion being a small diameter portion with a diameter smaller than the basic portion. The chain wound around the transmission sprocket with the largest outside diameter contacts the small diameter portion while the chain is not stagnant.

According to this, rotation of the guide roller further smoothens the guidance to align the stagnant part and accelerates the resolution of the stagnancy. In addition, the friction applied to the chain wound around the largest outside diameter transmission sprocket from the small diameter portion as the retreated portion is further reduced.

According to an embodiment of the present invention, the alignment guide consists of a first guide as the guide part and a second guide having a second guide surface which forms an alignment hole through which the chain passes, in conjunction with a first guide surface as the guide surface of the first guide. In addition, the second guide surface has a projection protruding toward the retreated portion in order to maintain the width of the alignment hole in the direction of inward or outward movement of the chain almost constant at any axial position.

According to this, due to the projection, the width of the alignment hole with the presence of the retreated portion is almost equal to the width of the alignment hole defined by the basic portion and the second guide surface's portion other than the projection, and therefore alignment takes place in the retreated portion properly.

According to an embodiment of the present invention, a bicycle transmission includes a drive sprocket which is rotated by a crankshaft with a transmission sprocket cluster including a plurality of transmission sprockets disposed in the axial direction. A shift mechanism shifts the chain among the transmission sprocket cluster as described in gear shift operation. The shift mechanism includes a guide pulley around which the chain is wound, and the guide pulley moving axially guides the chain wound around one active sprocket selected from among the transmission sprocket cluster. It has a limiting member for restricting disengagement of the chain from the guide pulley and the limiting member is located between the guide pulley and the active sprocket, outward in the radial direction of the guide pulley.

According to this, a torsion which occurs in the chain due to axial movement of the guide pulley upon the gear shift operation increases the friction between links of the chain and makes it difficult for the chain to sag along the guide pulley. Thus, when the chain is about to disengage or disengages from the guide pulley, the chain contacts the limiting member and restricts the disengagement of the chain.

According to an embodiment of the present invention, the limiting member is located between the rotational centerline of the crankshaft and the rotational centerline of the transmission sprockets, in a position to overlap the transmission sprockets when viewed sideways.

According to this, since the limiting member is in a position to overlap the transmission sprockets when viewed sideways, it is located in the space between the rotational centerline of the crankshaft and the rotational centerline of the transmission sprockets, and the distance between the crankshaft and the transmission sprockets need not be increased due to the presence of the limiting member.

According to an embodiment of the present invention, an alignment guide which is located between the drive sprocket and the transmission sprocket cluster to align a stagnant part of the chain is provided and the limiting member is molded integrally with the alignment guide.

According to this, since the limiting member is molded integrally with the alignment guide, there is no increase in the number of components.

According to an embodiment of the present invention, a bicycle transmission includes a drive sprocket which is rotated by a crankshaft with a transmission sprocket cluster including a plurality of transmission sprockets disposed in the axial direction. A shift mechanism shifts the chain among the transmission sprocket cluster as described in gear shift operation. The shift mechanism includes a guide pulley around which the chain is wound and a tension pulley which gives tension to the chain with the guide pulley moving axially together with the tension pulley upon a gear shift operation for guiding the chain wound around one active sprocket selected from among the transmission sprocket cluster. A part of the tension pulley contacts the chain consists of a surface on which the chain can slide axially.

According to this, since the chain axially moves across an extensive area in the circumferential direction of the tension pulley during axial movement of the tension pulley upon gear shift operation, the torsion in the chain decreases and the friction between links of the chain decreases as well. Thus, the chain easily sags along the contact part of the tension pulley and operates on the tension pulley smoothly.

According to an embodiment of the present invention, a transmission case which supports the crankshaft and the transmission sprocket cluster is provided and the transmission case is located between the front wheel and rear wheel of the bicycle.

In the transmission which is located between both wheels of the bicycle, or in the center of the bicycle, the drive sprocket and the transmission sprocket cluster are adjacent to each other and the torsion in the chain which occurs upon a gear shift operation tends to be considerable. However, the tension pulley substantially reduces the torsion and therefore the chain operates on the tension pulley smoothly.

According to an embodiment of the present invention, the following effect is provided. Namely a stagnant part of the chain is prevented from being caught in the drive sprocket. Since the friction applied to the chain which contacts the guide part is reduced, performance of the operation of the chain is improved.

According to an embodiment of the present invention, the resolution of the stagnancy of the chain is accelerated and also the friction applied from the guide roller to the chain wound around the largest outside diameter transmission sprocket is further reduced, so that the operating performance of the chain is further improved and the operating performance of the bicycle with the largest outside diameter transmission sprocket is improved.

According to an embodiment of the present invention, since alignment takes place properly even in the retreated portion, the friction from the guide part is reduced and proper alignment by the alignment guide is ensured.

According to an embodiment of the present invention, since the limiting member prevents or restricts disengagement of the chain, the operating performance of the chain on the guide pulley is improved.

According to an embodiment of the present invention, since the limiting member is located in the space between the rotational centerline of the crankshaft and the rotational centerline of the transmission sprockets, it is possible to provide the limiting member while keeping the compactness of the transmission.

According to an embodiment of the present invention, the transmission is provided with a limiting member that can be obtained without an increase in the number of components.

According to an embodiment of the present invention, since the chain operates on the tension pulley smoothly, the operating performance of the chain is improved.

According to an embodiment of the present invention, the transmission is located in the center of the bicycle. Thus, the operating performance of the chain is improved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic left side view of a bicycle with a transmission to which the present invention is applied;

FIG. 2 is a fragmentary sectional view showing the transmission of FIG. 1 with the second case removed. The solid lines indicate the condition at the highest speed gear position and the two-dot chain lines indicate the condition at the lowest speed gear position;

FIG. 3 is a sectional view taken along the line III-III in FIG. 2 showing part of the derailleur. The solid lines indicate the condition at the highest speed gear position and the two-dot chain lines indicate the condition at the lowest speed gear position;

FIG. 4(a) is a sectional view taken along the line IV-IV in FIG. 2 showing part of the derailleur. The solid lines indicate the condition at the highest speed gear position and the two-dot chain lines indicate the condition at the lowest speed gear position;

FIG. 4(b) is an enlarged view of a major part in FIG. 4(a);

FIG. 5(a) is a right side view of the sprocket cover of the transmission of FIG. 1;

FIG. 5(b) is a view taken from arrow B in FIG. 5(a);

FIG. 6 is an enlarged view of the alignment guide and its vicinity in FIG. 2;

FIG. 7 is a sectional view taken along the line VII-VII in FIG. 2;

FIG. 8 is a view of the first member of the alignment guide, taken from arrow VIII in FIG. 6;

FIG. 9 is a view which illustrates that the chain is stagnant in the vicinity of the alignment guide;

FIG. 10(a) is an enlarged view of the tension pulley and its vicinity in FIG. 4(a); and

FIG. 10(b) is a view of the tension pulley, taken from arrow B in FIG. 10(a).

### DETAILED DESCRIPTION OF THE PREFERRED EMBODIMENTS

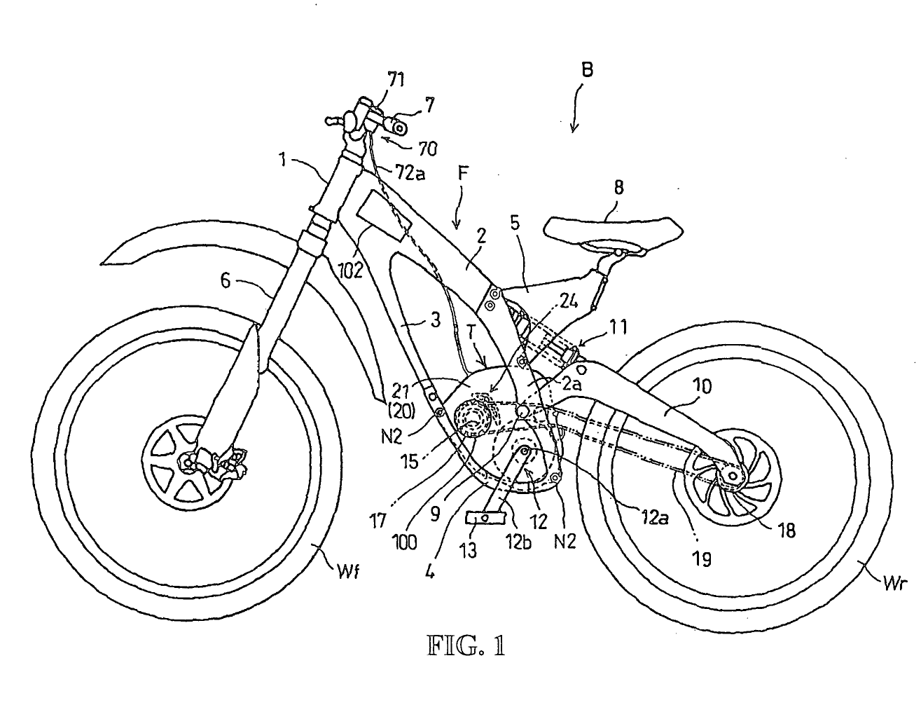

Referring to FIG. 1, a bicycle B is equipped with a transmission T as described in the present invention that includes a body frame F with a pedaled crankshaft 12 and a transmission system which transmits power of the crankshaft 12 to a rear wheel Wr as a drive wheel. This transmission system includes a transmission T, an output shaft 15 which is rotated by power after speed change by the transmission T and a driving power transmission mechanism which transmits power of the output shaft 15 to the rear wheel Wr.

The body of the bicycle B has a body frame F and a swing arm 10. The body frame F includes a head pipe 1 steerably supporting front forks 6 which pivotally support a front wheel Wf at its bottom and has handlebars 7 at its top. A bifurcated main frame 2 stretches downwardly and obliquely rearwardly from the head pipe 1. A down tube 3 stretches downwardly and obliquely rearwardly from the front end of the main frame 2. A pair of under tubes 4 (left and right) connect the rear end of the down tube 3 with the pair of rear ends of the main frame 2. A saddle frame 5 stretches from the main frame 2 and supports the saddle 8.

In the specification and the claims, top, bottom, front, rear, left and right correspond to the bicycle's top, bottom, front, rear, left and right, respectively. Also, the “axial direction” means the direction of the rotational centerline L3 of the transmission sprockets 41 to 47 and an the expression “viewed sideways” means that something is “viewed from the axial direction.”

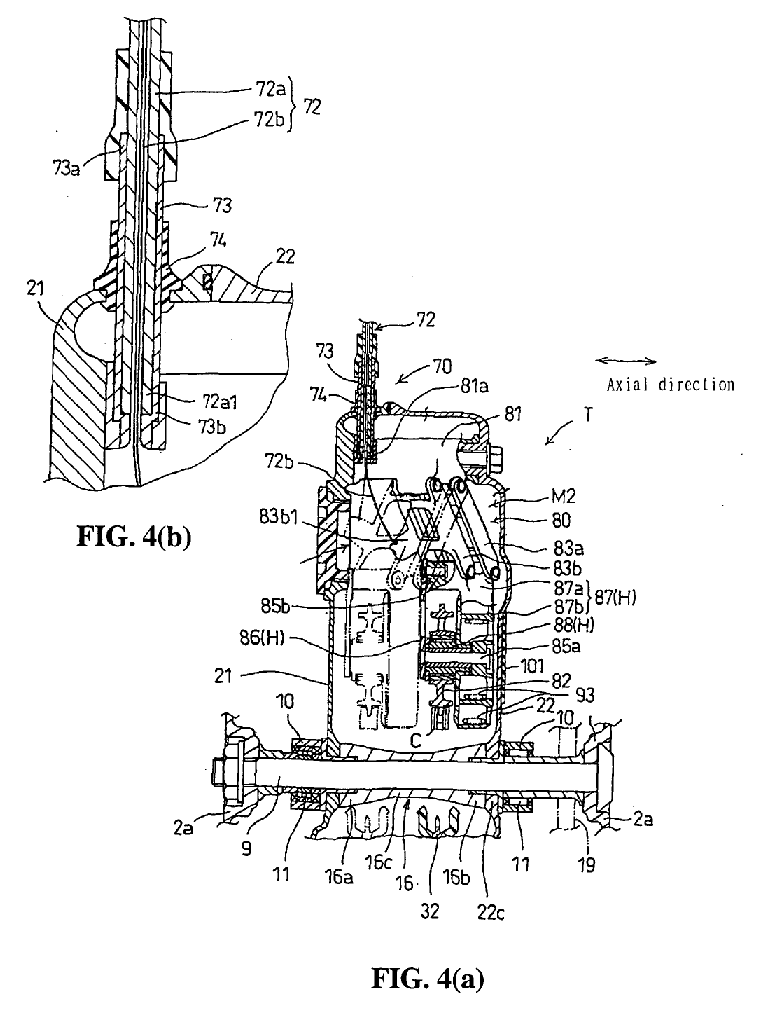

On a pivot shaft 9, see FIG. 4(a), that is provided on a pair of rear portions 2a of the main frame 2, the front ends of a pair of swing arms (left and right) 10 which pivotally support the rear wheel Wr at the rear ends are swingably supported through a bearing 11. The swing arms 10 are both connected through the suspension S to the main frame 2 so that they can swing up or down around the pivot shaft 9 together with the rear wheel Wr.

The transmission T, and a main shaft 12a of the crankshaft 12 and the output shaft 15 which are rotatably supported by the transmission T are located in the center of the bicycle B, namely, between the front wheel Wr and rear wheel Wr, at the bottom of the body frame F, in the space between the rear portions 2a of the main frame 2 and the under tubes 4. The above driving power transmission mechanism is located on the right of the transmission T.

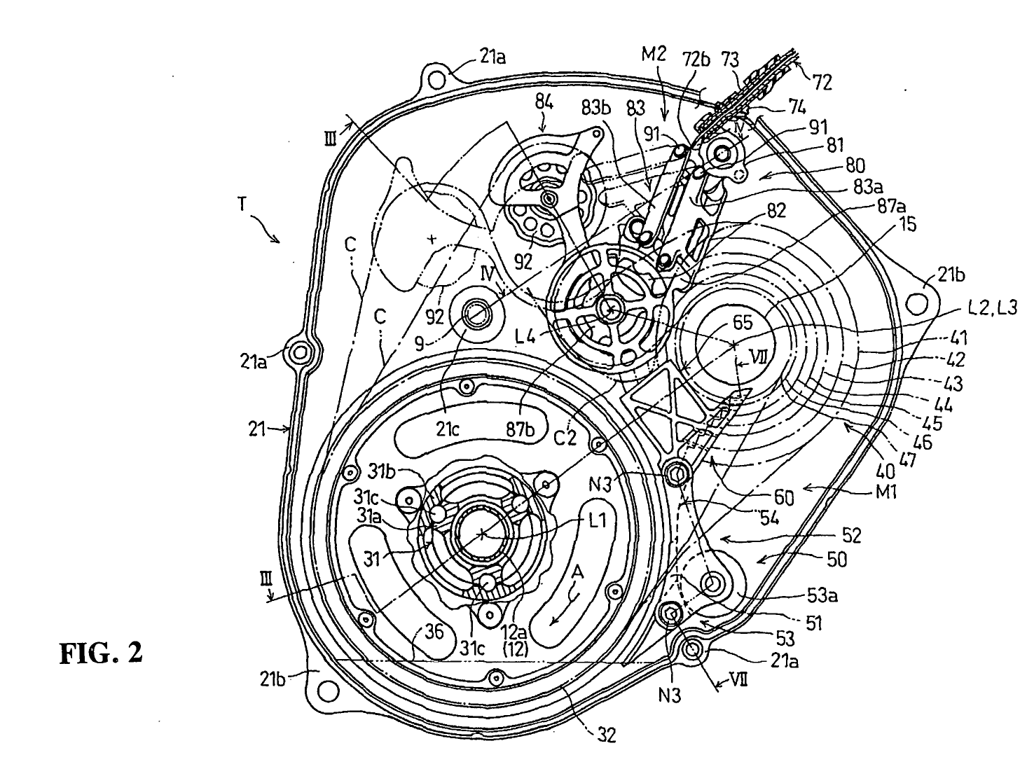

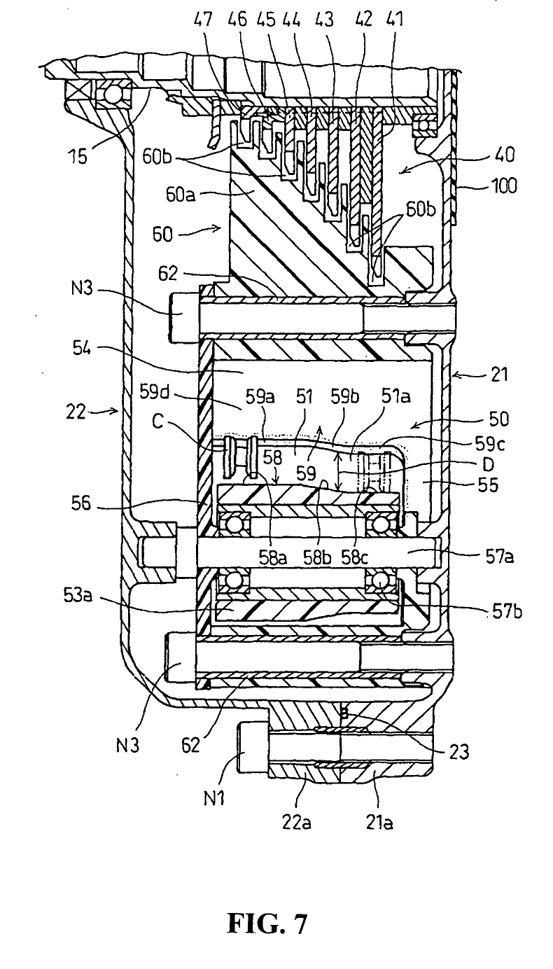

Referring to FIGS. 2 to 4(a) as well, the transmission T has a metal transmission case 20 that includes a pair of cases (left and right). A first case 21 and a second case 22 are provided which are liquid-tightly coupled through a seal member 23, see FIG. 7, by a bolt N1 at bosses 21a and 22a formed on their peripheries. The transmission case 20 is fixed onto the main frame 2 and the under tubes 4 at a pair of mounting tabs. FIG. 2 illustrates mounting tabs 211b of the first case 21 that are formed at the peripheries of the cases 21 and 22, with bolts N2, see FIG. 1.

The crankshaft 12 includes a main shaft 12a that penetrates through the lower part of the transmission case 20 in the left/right direction. A pair of crank arms 12b are respectively coupled to the main shaft 12a left and right ends that project outward from the transmission case 20. The crankshaft 12 is rotatably supported by the first and second cases 21 and 22 through a pair of bearings 14. A pedal 13, see FIG. 1, is rotatably attached to each of the crank arms 12b.

The output shaft 15 is disposed obliquely upwardly in front of the main shaft 12a and the pivot shaft 9 is disposed almost just above the main shaft 12a in a way that the rotational centerline L2 of the output shaft 15 and the centerline of swing of the swing arms 10 are parallel to each other and also to the rotational centerline L1 of the crankshaft 12 and also they fall within the orbit of rotation of the crank arms 12b. Since the main shaft 12a and the output shaft 15 are disposed between the front wheel Wf and rear wheel Wr, they are closer to each other than in a bicycle whose output shaft is coaxial with the rear wheel.

The pivot shaft 9, which is fastened and fixed on the main frame 2, passes through a through hole in a pivot collar 16 which axially touches the bosses 21c and 22c formed inside the first and second cases 21 and 22 and supports the first and second cases 21 and 22. Both ends 16a and 16b of the pivot collar 16, which consists of axially disposed cylinders with different outside diameters, have a larger diameter than its central part 16c with a small diameter. Due to the large diameter of the ends 16a and 16b, the pivot collar 16 is strong enough to bear the fastening load on the pivot shaft 9. In addition; due to the small diameter of the central part 16c, the pivot collar 16 is lightweight and can avoid interference with the drive sprocket 32 and the chain C to permit the construction of a compact transmission T.

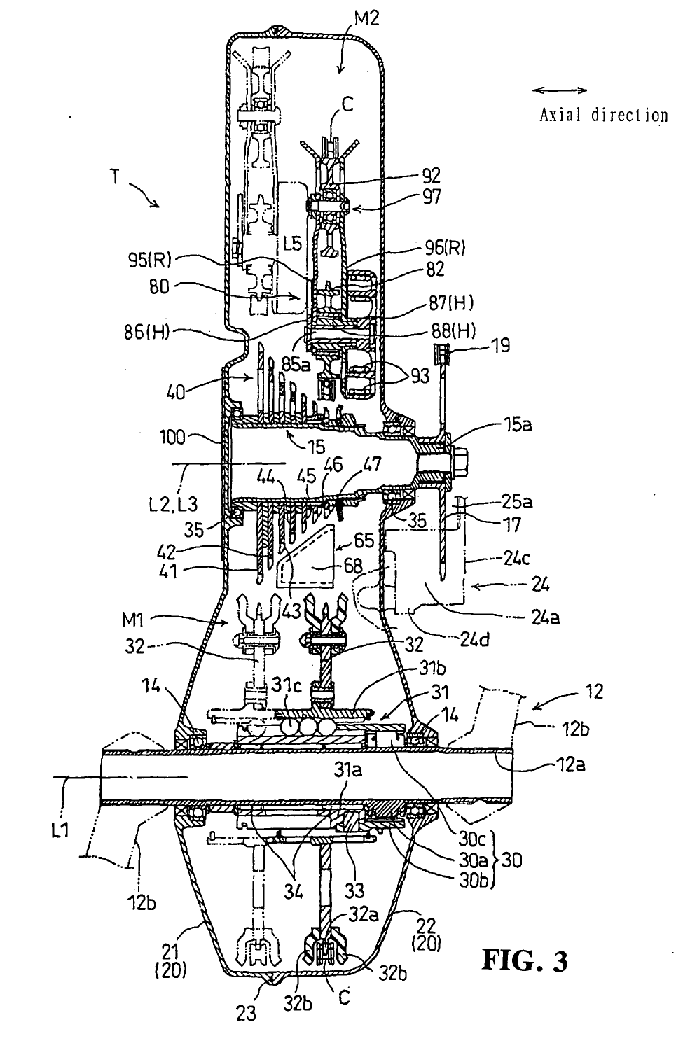

Referring to FIGS. 1 and 3, the output shaft 15 housed in the transmission case 20 has an end 15a projecting to the right from the second case 22 and an output drive sprocket 17 as an output drive rotator that is coupled with the end 15a. An output chain 19 is provided as a flexible output endless transmission belt that is wound around the drive sprocket 17. An output driven sprocket 18 is provided as an output driven rotator which is drivably connected with the rear wheel Wr. The drive sprocket 17, driven sprocket 18 and chain 19 constitute the above driving power transmission mechanism.

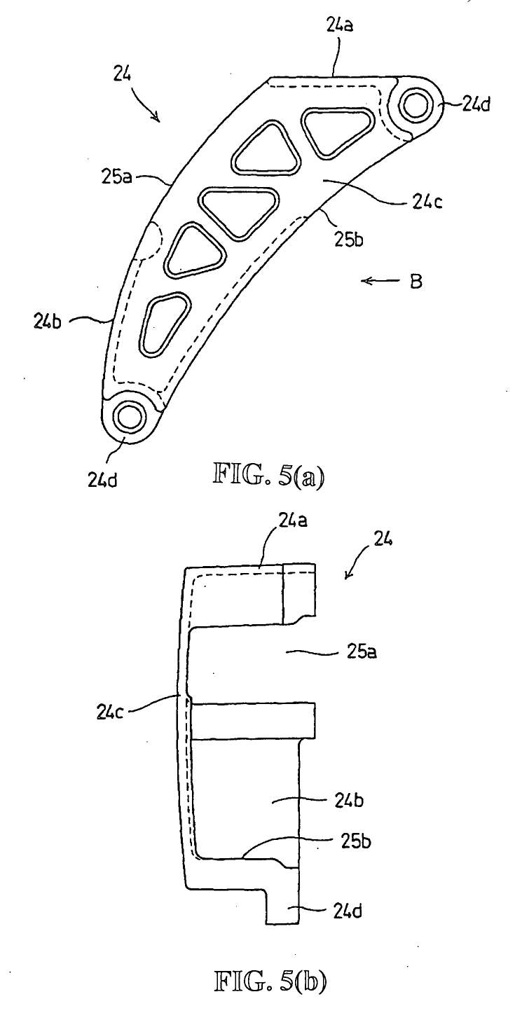

Referring to FIGS. 1, 3 and 5, a synthetic resin sprocket cover 24 partially covers the drive sprocket 17 and the chain 19 from above, behind and the right is attached to the transmission case 20. Located within the orbit of crank arm rotation, the sprocket cover 24 includes a top wall 24a for covering the drive sprocket 17 and the chain 19 from above. A back wall 24b is located near the main shaft 12a of the crankshaft 12 and covers the drive sprocket 17 from behind. A side wall 24c covers the right side. A pair of mounting bosses 24d is provided through which bolts to be threaded into the second case 22 are passed. In addition, holes 25a and 25b through which the chain 19 is passed are made in the sprocket cover 24, between the top wall 24a and the back wall 24b and between both the mounting bosses 24d, respectively. The sprocket cover 24 prevents the feet of the rider operating the pedals from touching the drive sprocket 17 and the chain 19.

Next, a further explanation will be given, focusing on the transmission T.

Referring to FIGS. 2 to 3, the transmission T includes: a transmission case 20 with a chain type transmission mechanism M1 and a gear shift mechanism M2 for placing the transmission mechanism M1 into a desired position as described in gear shift operation. The transmission mechanism M1 and a derailleur 70 (stated later) as a component of the gear shift mechanism M2 are housed in the transmission case 20.

The transmission mechanism M1 includes a one-way clutch 30 with a ball spline 31 as a sliding mechanism. A drive sprocket 32 is provided with a transmission sprocket cluster 40 consisting of a plurality of transmission sprockets 41 to 47. An endless transmission chain C is provided with an alignment guide 50 and a limiting member 65.

In the drive sprocket 32, a pair of circular synthetic resin side plates 32b, that prevent disengagement of the chain C, is provided on both sides of the teeth 32a to engage with the chain C. Since the side plates 32b are made of synthetic resin, the drive sprocket 32 is lightweight.

The main shaft 12a of the crankshaft 12, which is rotated by the rider, is drivably connected with the drive sprocket 32, located coaxially, through the one-way clutch 30. The one-way clutch 30 includes a clutch inner 30a which consists of part of the main shaft 12a, a clutch outer 30b with a ratchet geared inner periphery and a clutch element 30c which consists of a claw to engage with the ratchet gear, located between the clutch inner 30a and the clutch outer 30b. The one-way clutch 30 transmits the rotation of the crankshaft 12 only in the normal rotation direction A (hereinafter, the normal rotation direction of various shafts and sprockets-upon normal rotation of the crankshaft 12 is indicated by symbol A) to the drive sprocket 32.

The ball spline 31 is provided for enabling the drive sprocket 32 to move in the direction of the rotational centerline L1 of the main shaft 12a (which corresponds to the axial direction) and for rotating the drive sprocket 32 together with the clutch outer 30b of the one-way clutch 30 that is located between the one-way clutch 30 and the drive sprocket 32. The ball spline 31 includes an inner cylinder 31a which is integrally coupled with the clutch outer 30b through a connecting pin 33 and rotatably supported on the outer periphery of the main shaft 12a through a bearing 34. An outer cylinder 31b is provided which is coaxial with the inner cylinder 31a outwardly in the radial direction of the inner cylinder 31a and is integrally coupled with the drive sprocket 32. A plurality of balls 31c are located between the inner cylinder 31a and the outer cylinder 31b that are housed in a way to be able to roll across three pairs of housing grooves made in the inner cylinder 31a and the outer cylinder 31b, stretching parallel to the rotational centerline L1. Therefore, although the outer cylinder 31b and the drive sprocket 32 rotate together with the inner cylinder 31a through the balls 31c, they can move in the axial direction while the inner cylinder 31a cannot move in the axial direction.

Lubricating oil reserved in the transmission case 20 is used to lubricate parts of the transmission T which need lubrication such as the chain C, various sprockets 32, 41 to 47 to engage with the chain C, sliding parts of the crankshaft 12, one-way clutch 30, ball spline 31 and other sliding parts. For this reason, lubricating oil is reserved at the bottom of the transmission case 20 so that the drive sprocket 32's outer periphery including its teeth is below an oil surface 36. Drops of lubricating oil pumped up by the drive sprocket 32 and the chain C and lubricant oil adhering to the chain C are supplied to various parts to be lubricated.

A plurality of transmission sprockets with different outside diameters (addendum circle diameters), seven transmission sprockets 41 to 47 in this embodiment, are splined to the output shaft 15, which is rotatably supported by the transmission case 20 through a pair of bearings 35 held by the cases 21 and 22, respectively, in a way that they rotate integrally with the output shaft 15 and are coaxial with the output shaft 15. Therefore, the rotational centerline L3 of the transmission sprockets 41 to 47 coincides with the rotational centerline L2 of the output shaft 15, which is parallel to the rotational centerline L1. All the transmission sprockets 41 to 47 are axially arranged in the ascending order of speed and in the descending order of diameter, from the lowest speed 1-speed transmission sprocket 41 to the highest speed 7-speed transmission sprocket 47.

The chain C is wound between the drive sprocket 32 and an active sprocket as one transmission sprocket 41 to 47 which is selected from among the transmission sprocket cluster 40 by the gear shift mechanism M2 (hereinafter called an “active sprocket”). Therefore, the output shaft 15 is rotated by the crankshaft 12 at the gear ratio which is determined by the active sprocket drivably connected through the chain C with the drive sprocket 32.

Referring to FIG. 2 and FIGS. 6 to 9, an alignment guide 50 is located between the drive sprocket 32 and the transmission sprocket cluster 40. More specifically, on the tight side of the chain C driven by the normally rotating drive sprocket 32, near the wind-in part of the drive sprocket 32; when a stagnant part Cl, see FIG. 9, an extremely loose or folded part of the chain C, is generated as the tension of the tight side lowers, it prevents the stagnant part C1 from being caught in the drive sprocket 32.

The alignment guide 50 includes a guide part 52 which has a slightly larger axial width than the width of axial movement of the chain C as wound around each transmission sprocket 41 to 47 of the transmission sprocket cluster 40 and forms an alignment hole 51 through which the chain C in alignment passes. A limiter 60 is provided which restrains the chain C as unwound from each transmission sprocket 41 to 47 from moving inward (inside the chain orbit).

The guide part 52, which guides the stagnant part C1 of the chain C approaching the alignment guide 50 in a way to let it pass through the alignment hole 51 as aligned, is composed of an outer guide 53 as a first guide which is located outside the chain C (outside the chain orbit) with respect to the alignment hole 51 an inner guide 54 as a second guide which is located inside the chain C with respect to the alignment hole 51 and side guides 55 and 56 which are located on both sides of the alignment hole 51 in the axial direction. The outer guide 53, which forms the alignment hole 51 in conjunction with the inner guide 54 and side guides 55 and 56, includes a guide roller 53a as an inlet portion which lies near the transmission sprocket cluster 40 and guides the chain C to the alignment hole 51 to form an inlet 51a of the alignment hole 51 and an outlet portion 53b which lies near the drive sprocket 32 to form an outlet 51b of the alignment hole 51.

The outlet portion 53b, inner guide 54, limiter 60 and left side guide 55 are integrally built as a single first member, and the right side guide 56 is built as a second member. The first member and second member and the guide roller 53a are made of self-lubricating or low friction synthetic resin. The first and second members are coupled with the first case 21 by means of a pair of bolts N3 passed through inner holes of a pair of collars 62 inserted into the members so that the alignment guide 50 is fixed on the transmission case 20. Therefore, the side guide 56 is detachably coupled with the first member. The guide roller 53a is rotatably supported through a bearing 57b by a support shaft 57a both ends of which are supported by the side guide 55 and first case 21 on the left and by the side guide 56 and second case 22 on the right.

The guide roller 53a has an outer circumferential surface 58 as a first guide surface which guides the stagnant part C1 of the chain C so as to align it. The outer circumferential surface 58 has, in the axial direction, a large diameter portion 58a as a basic portion on the side of the transmission sprocket 47 with the smallest outside diameter, and a small diameter portion, 58b, 58c, on the side of the transmission sprocket 41 with the largest outside diameter which is more retreated outside the chain C than the large diameter portion 58a.

The small diameter portion, 58b, 58c, which is smaller in diameter than the large diameter portion 58a, consists of: the smallest diameter portion 58c as the most retreated portion and a tapered portion 58b as the transitional retreated portion which continuously retreats from the large diameter portion 58a to the smallest diameter portion 58c. The diameter of the tapered portion 58b continuously decreases from the largest diameter portion 58a to the smallest diameter portion 58c.

The inner guide 54 has a second guide surface 59 which guides the stagnant part C1 of the chain C so as to align it. The guide surface 59 includes in the axial direction an usher portion 59d which lies nearer to the chain C entry side than the alignment hole 51 and ushers the chain C into the alignment hole 51 and a basic portion 59a located on the side of the smallest outside diameter transmission sprocket 47 and projection 59b, 59c located on the side of the largest outside diameter transmission sprocket 41 projecting toward the small diameter portion 58b, 58c, which respectively correspond to the large diameter portion 58a and small diameter portion 58b, 58c to form the alignment hole 51 in conjunction with the large diameter portion 58a and small diameter portion 58b, 58c of the guide roller 53a. The projection 59b, 59c consists of the largest projection 59c projecting toward the smallest diameter portion 58c and the transitional projection 59b projecting toward the tapered portion 58b, which respectively correspond to the smallest diameter portion 58c and the tapered portion 58b.

The large diameter portion 58a and basic portion 59a, the tapered portion 58b and transitional projection 59b, and the smallest diameter portion 58c and largest projection 59c, which are opposite to each other, maintain the width D of the alignment hole 51 in the direction of inward or outward movement of the chain C upon shift of the chain C among the transmission sprocket cluster 40 almost constant at any axial position.

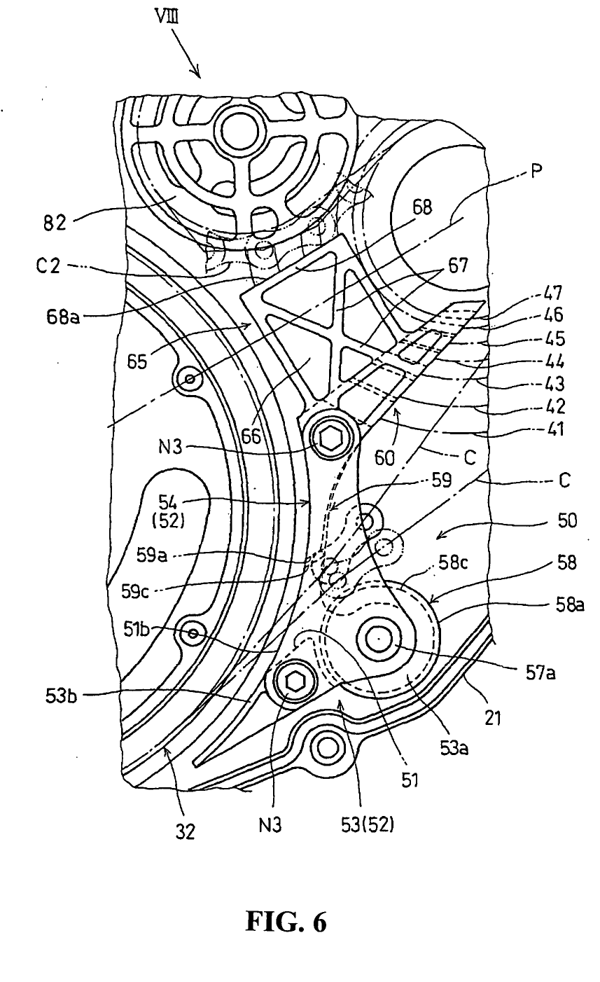

Assuming that gear shift positions obtained by the transmission sprocket cluster 40 are divided into two groups, low speed positions and high speed positions, when the chain C is not stagnant, the chain C as wound around the transmission sprockets 41, 42 and around the transmission sprocket 43 as active sprockets at low speed positions (namely low speed transmission sprockets) respectively for contacting the smallest diameter portion 58c and tapered portion 58b of the guide roller 53a to give a slight tension (part of the chain C wound around the transmission sprocket 41 is indicated by two-dot chain line in FIG. 6), and the chain C as wound around the transmission sprockets 44 to 47 as active sprockets at high speed positions (namely high speed transmission sprockets) contacts the basic portion 59a of the inner guide 54 to give a slight tension (art of the chain C wound around the transmission sprocket 47 is indicated by solid line in FIG. 6) so as to prevent the chain C from loosening on its tight side.

When the chain C is not stagnant, the chain C as wound around the transmission sprockets 41, 42 and around the transmission sprocket 43 does not touch the largest projection 59c and the transitional projection 59b of the inner guide 54 respectively, and the chain C as wound around the transmission sprockets 44 to 47 does not contact the large diameter portion 58a of the guide roller 53a.

On the other hand, when the chain C is stagnant, as typically illustrated in FIG. 9, the chain C as wound around the transmission sprockets 41, 42, around the transmission sprocket 43 and around the transmission sprockets 44 to 47, respectively, contacts the smallest diameter portion 58c, tapered portion 58b and large diameter portion 58a of the guide surface 58 of the guide roller 53a and contacts the usher portion 59d, largest projection 59c, transitional projection 59b and basic portion 59a of the guide surface 59 of the inner guide 54 and guides the stagnant part Cl so as to let the chain C pass through the alignment hole 51 as aligned.

The limiter 60, which is located in a position to overlap the transmission sprockets 41 to 47 when viewed sideways, extends from the inner guide 54 toward the transmission sprockets 41 to 47 and has a tip 60a in which as many grooves 60b, through which the teeth of the transmission sprockets 41 to 47 pass individually, as the transmission sprockets 41 to 47 are formed.

Therefore, when the bicycle B severely moves up and down in a short time, for example, because of a rough road surface, even if vertical vibration on the tight side of the chain C or inward or outward vibration of the chain C (hereinafter “inward/outward”) occurs, it touches the outer guide 53 and the inner guide 54, which limits the amplitude of vibration and thus suppresses vibration of the chain C and allows the chain C to pass through the alignment hole 51 as aligned, thereby permitting a smooth operation of the chain C.

In an operating condition of the bicycle B in which the chain C has a stagnant part C1 due to a tension decrease on the tight side of the chain C, for instance, when the bicycle B is freewheeling forward with the crankshaft 12 at a stop or rotating in the reverse direction, the drive sprocket 32 is rotated in the normal rotational direction A through the chain C by the torque transmitted from the rear wheel Wr to the transmission sprocket cluster 40 through the driving power transmission mechanism and the output shaft 15. At this moment, it may happen that the tension of the tight side of the chain C declines and a stagnant part C1 is generated on the tight side; especially when the bicycle B moves forward in a condition wherein the crankshaft 12 suddenly stops or rotates in the reverse direction after its normal rotation, it may happen that the chain C loosens considerably and a folded stagnant part C1 is generated on the wind-in side of the drive sprocket 32. In such a case, without the alignment guide 50, the stagnant part C1 might be caught in the drive sprocket 32.

However, even if a stagnant part C1 is generated on the tight side, due to the presence of the alignment guide 50 the stagnant part C1 contacts the outer guide 53 and the inner guider 54 and is thus guided in a way to be aligned, so that the chain C passes through the alignment hole 51 as aligned and operates smoothly.

Referring to FIGS. 1 to 4, the gear shift mechanism M2 includes a gear shift operation mechanism 70, and a derailleur 80 as a shift mechanism which shifts the chain C from one sprocket to another among the transmission sprocket cluster 40 as described in a gear shift operation by the gear shift operation mechanism 70. The chain C is put around the drive sprocket 32, an active sprocket and a guide pulley 82 and a tension pulley 92, both located on the loose side of the chain C which is driven by normal rotation of the crankshaft 12.

The gear shift operation mechanism 70, which is connected with the derailleur 80 in the transmission case 20, includes a gear shift operation member 71, see FIG. 1, such as a shift lever to be operated by the rider and an operational cable 72 as an operational power transmission member which connects the gear shift operation member 71 with the derailleur 80 to transmit the operation of the gear shift operation member 71 to the derailleur 70.

The operational cable 72 includes an outer cable 72a in the form of a flexible tube held by the body frame F and a flexible inner cable 72b inserted into the outer cable 72a. The inner cable 72b is coupled with the gear shift operation member 71 at its bottom and with the derailleur 80 at its top.

When the operational cable 72 is mounted in the transmission case 20, before inserting the operational cable 72 in a grommet 74 fitted to the first case 21, the portion of the operational cable 72 near its top is inserted into a cylindrical insertion tube 73 latched to a retainer 81a with a recess, provided at the base 81 of the derailleur 80 so that the operational cable 72 and the insertion tube 73 are joined together. In this condition, the outer cable 72a inserted from one end 73a of the insertion tube 73 is latched to the insertion tube 73, and the inner cable 72b inserted into the outer cable 72a through a hole at the other end 73b of the insertion tube 73 extends outside the insertion tube 73. Then, the insertion tube 73 with the operation cable 72 inserted therein is inserted in the grommet 74 from outside the first case 21 and held by the retainer 81a. At this time, the inner cable 72b is passed through a hole at the bottom of the retainer 81 a before an engaging part at its tip is latched to a link 83b of a parallel link mechanism 83. Since the operation cable 72 passed through the transmission case 20 and held by the retainer 81 a, as integral with the insertion tube 73, is thus inserted in the grommet 74 fitted to the transmission case 20 together with the insertion tube 73, it is easy to fit the operation cable 72 to the derailleur 80.

Referring to FIGS. 2 to 3, the derailleur 80 located above the main shaft 12a of the crankshaft 12 includes a cylindrical base 81 molded integrally with the retainer 81a which is fixed and held on the cases 21 and 22 and holds the outer cable 72a, a guide pulley 82 which, when shifting the chain C among the transmission sprockets 41 to 47, guides the chain C in a way to wind it around an active sprocket, a holder H which rotatably supports the guide pulley 82, a parallel link mechanism 83 having a pair of links 83a and 83b which couple the base 81 and holder H and move the holder H and guide pulley 82 in the axial direction and the radial direction of the rotational centerline L3 as described in gear shift operation by the gear shift operation mechanism 70 and a tensioner 84 for adjusting the tension of the chain C.

The holder H includes a first holder part 86 and a second holder part 87 which are located on both sides, in the axial direction, of the guide pulley 82 having a rotational centerline L4 parallel to the rotational centerline L3, or on the left and right, respectively, and coupled by a pair of rivets 85a and 85b and a support part 88 which rotatably supports the guide pulley 82. The support part 88 swingably supports a pair of arms, a first arm part 95 and a second arm part 96, which will be described later.

The second holder part 87 includes a coupling part 87a which is located outwardly in the radial direction of the guide pulley 82 and is pivotally coupled with the pair of links 83a and 83b of the parallel link mechanism 83. A spring housing 87b is provided which is located on the right of the guide pulley 82 and houses a tension spring 93. The links 83a and 83b are pivotally fitted to the base 81 through a pair of support shafts 91 provided at the base 81, and as they are operated through the inner cable 72b latched to the coupling part 83b1 of the link 83b, they swing around a pair of swing centerlines defined by the support shafts 91 and guide the guide pulley 82 along a cluster of addendum circles consisting of the addendum circles of the transmission sprockets 41 to 47.

Referring to FIGS. 2, 3 and 6, the limiting member 65, which receives the chain C disengaged from the guide pulley 82 to limit the disengagement, is located between the guide pulley 82 and an active sprocket, on the wind-out side of the guide pulley 82 rotating in the normal rotational direction A (on the wind-in side of the guide pulley 82 rotating in the reverse direction), outward from a tangent line common to the addendum circle of the guide pulley 82 and the addendum circle of the active sprocket in the radial direction of the guide pulley 82 when viewed sideways. FIGS. 2 and 6 illustrate an example of a disengaged part C2 of the chain C by two-dot chain lines. This kind of disengagement of the chain C from the guide pulley 82 occurs when the transmission sprockets 41 to 47 are not rotating normally. More specifically, when the bicycle B is operating backward, namely the transmission sprocket 41 to 47 is rotating in the reverse direction or when the bicycle is stationary, namely the transmission sprockets 41 to 47 are stationary.

The limiting member 65 lies between the rotational centerline L1 of the crankshaft 12 and the rotational centerline L3 of the transmission sprockets 41 to 47, in a position to cross a plane P including the rotational centerlines L1 and L3 and overlap the transmission sprockets 41 to 47 when viewed sideways, and molded integrally with the above first member of the alignment guide 50, projecting from the limiter 60 toward the guide pulley 82. The limiting member 65 uses the alignment guide 50 and is separate from the holder H supporting the guide pulley 82.

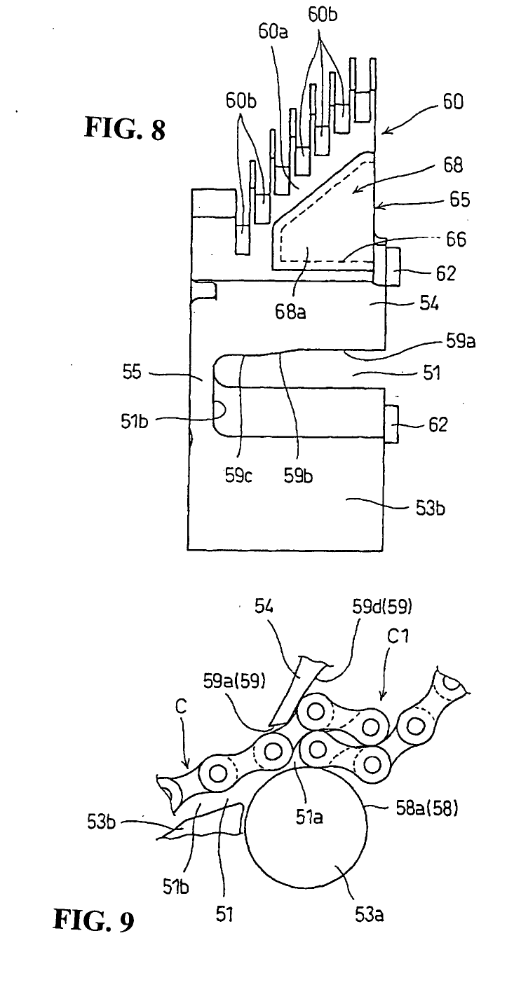

Referring to FIG. 8 as well, the limiting member 65 has a recess 66 and takes the form of a box reinforced by a rib 67 and is lightweight. The contact part 68 for contacting the disengaged chain C consists of a flat wall having a contact surface which is nearer to the guide pulley 82 than to the plane P and parallel to the plane P and stretches across the axial movement area of the chain C wound around plural transmission sprockets 43 to 47.

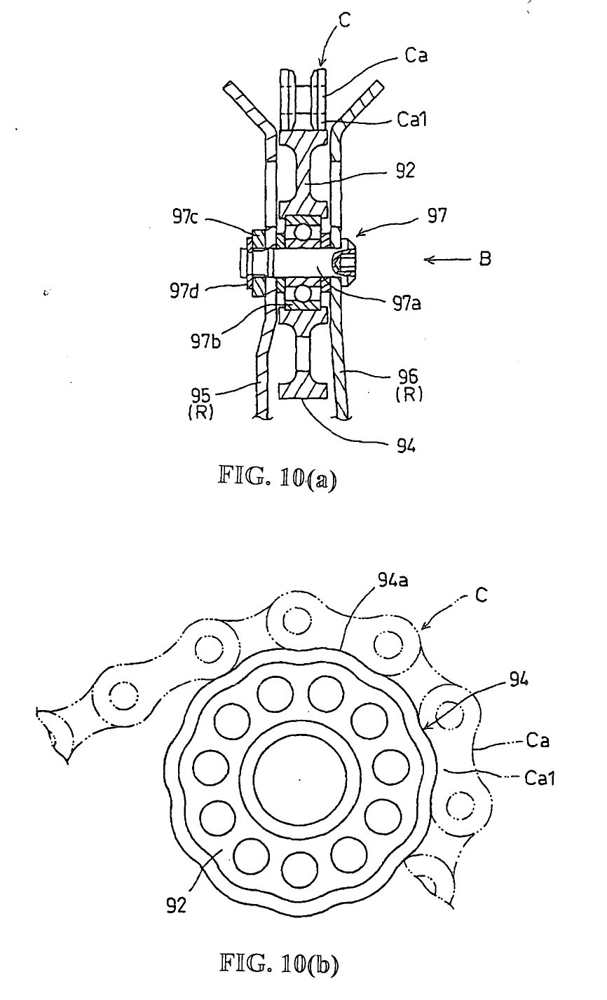

Referring to FIGS. 2, 3 and 10, the tensioner 84 includes a tension pulley 92 which presses the chain C between the drive sprocket 32 and the guide pulley 82 to give tension to the chain C, an arm R which is located between the first and second holder parts 86 and 87 in the axial direction and swingably supported by the retainer 88 of the holder H and rotatably supports the tension pulley 92 and a tension spring 93.

The tension pulley 92 has an outer circumferential surface 94 as a part to contact the chain C. The outer circumferential surface 94 consists of an axially parallel plane so that in a gear shift operation by the derailleur 80, when the tension pulley 92 moves axially together with the guide pulley 82, it constitutes a surface which allows the chain C to slide axially, due to a torsion in the chain C which occurs because the tension pulley 92 moves before the axial movement of the drive sprocket 32 following the axial movement of the tension pulley 92, and a link Ca of the chain C contacts the outer circumferential surface 94 at an outer border Ca1 inside it.

The outer circumferential surface 94, which almost fits the outer border Ca1 in the circumferential direction (or when viewed sideways), consists of a curved surface having a convex part 94a which matches a concave part of the outer border Ca1. This suppresses slippage of the chain C on the outer circumferential surface in the operating direction.

The arm R consists of a pair of arm parts, a first arm part and a second arm part 95 and 96, located on both sides of the tension pulley 92 or left and right in the axial direction, respectively, and located between the first and second holder parts 86 and 87 in the axial direction; and a support part 97 which rotatably supports the tension pulley 92. The support part 97 consists of a bolt 97a as a coupling means to couple the first and second arm parts 95 and 96 and enable the tension pulley 97 to be attached to, and detached from, the arm parts 95 and 96 and a bearing 97b fitted onto the bolt 97a to support the tension pulley 92. The bolt 97a has a groove to house a retaining ring 97d which prevents loosening of a nut 97C screwed on the bolt 97a.

Taking advantage of the fact that the tension pulley 92 can be attached to, and detached from, the arm R, this embodiment uses an endless chain C. More specifically, the endless chain C is wound around the drive sprocket 32, transmission sprocket 41 to 47 and guide pulley 82 with the bolt 97a removed, the tension pulley 92 removed from the arm R and the side guide 56 and the side guide 56 of the alignment guide 50 as the second member, see FIG. 7, removed. After that, the tension pulley 92 is attached to the arm R with the bolt 97a from inside the chain C and in the alignment guide 50, the first member is attached to the second member. This process, in which the endless chain C is wound around the sprockets, eliminates the need for a step of connecting both chain ends which a chain having ends would require. In addition, the difference in the coupling force between links Ca is reduced.

The tension spring 93, composed of two torsion coil springs with different diameters, biases the arm R and the tension pulley 92 around the rotational centerline L4 clockwise as seen in FIG. 2 by its resilience to push the tension pulley C against the chain C.

Referring to FIG. 7 and FIG. 4(a), soundproof sheets 100 and 101 of an elastic material with rubber elasticity, which attenuate the noise of collision between the chain C and the transmission sprockets 41 to 47 which is generated when shifting the chain C to another sprocket, are attached at positions of the first and second cases 21 and 22 where they overlap the transmission sprocket cluster 40 and the guide pulley 82 when viewed sideways. These soundproof sheets 100 and 101 attenuate and reduce the collision noise transmitted to the transmission case 20. Referring to FIG. 1, the above collision noise transmitted to the hollow main frame 2 and noise of flying pebbles hitting the main frame 2 are effectively attenuated by a soundproof sheet 102 attached to the left and right sides of the front part, a wide area of the main frame 2.

Next, the functions and effects of the abovementioned embodiment will be explained.

When the rider drives the crankshaft 12 in the normal rotational direction A, or when the bicycle B operates forward while the crankshaft 12 rotates in the reverse direction or is at a stop, upon the operation of the gear shift operation member 71, the derailleur 80, arm R and tension pulley 92 are placed in their basic 7-speed position as indicated by solid lines in FIGS. 2 to 4(a) and the transmission sprocket 47 is selected as an active sprocket from among the transmission sprocket cluster 40, and the chain C is placed around the drive sprocket 32 and the transmission sprocket 47 in their positions as indicated by solid lines in FIGS. 3 and 4(a). The crankshaft 12, which rotates in the normal rotation direction A as the rider works the pedals 13, rotates the drive sprocket 32 through the one-way clutch 30, and the drive sprocket 32 rotates the transmission sprocket 47, output shaft 15 and drive sprocket 17 through the chain C at a gear ratio determined by the sprockets 32 and 47. Then, the drive sprocket 17 rotates the driven sprocket 18 and rear wheel Wr through the chain 19.

When the gear shift operational member 71 is operated to select as an active sprocket, for example, the transmission sprocket 41, among lower speed transmission sprockets 41 to 46 for gear shift from the 7-speed position to another position, the inner cable 72b activates the parallel link mechanism 83 of the derailleur 80 and the parallel link mechanism 83 moves the holder H, guide pulley 82, arm R and tension pulley 92 to the left in the axial direction and outwardly in the radial direction with respect to the rotational centerline L3 and brings them into the 1-speed position as indicated by two-dot chain lines in FIGS. 2 to 4(a). Then, the chain C, which moves to the left together with the guide pulley 82 and the tension pulley 92, moves the drive sprocket 32 to the left in the axial direction of the main shaft 12a of the crankshaft 12 and brings the drive sprocket 32 into the position as indicated by two-dot chain lines in FIGS. 3 and 4(a). At this time, the chain C is put around the transmission sprocket 41 and drivably coupled with the drive sprocket 32 through the chain C.

When the gear shift operation member 71 is operated to select a higher speed transmission sprocket 42 to 47 for a gear shift from this 1-speed position, the inner cable 72b activates the parallel link mechanism 83 of the derailleur 80 and the parallel link mechanism 83 moves the holder H, guide pulley 82, arm R and tension pulley 92 to the right in the axial direction and inward in the radial direction with respect to the rotational centerline L3. Thereafter; the chain C, which moves to the right together with the guide pulley 82 and the tension pulley 92, moves the drive sprocket 32 to the right with respect to the main shaft 12a and at the same time, the chain C is wound around the selected transmission sprocket 42 to 47.

As mentioned above, the derailleur 80, which is activated as described in a gear shift operation by the gear shift operation mechanism 70, shifts the chain C among the transmission sprockets 41 to 47, so that the bicycle B operates at a gear ratio determined by a selected active sprocket around which the chain C is wound, and the drive sprocket 32.

In this transmission T, the alignment guide 50 consists of the guide roller 53a having an outer circumferential surface 58 which guides a stagnant part C1 of the chain C so as to align it and the outer circumferential surface 58 has, in the axial direction, a large diameter portion 58a on the side of the transmission sprocket 47 with the smallest outside diameter, and a smallest diameter portion 58c on the side of the transmission sprocket 41 with the largest outside diameter and a tapered portion 58b, which are more retreated outside the chain C than the large diameter portion 58a and the chain C, which is wound around a transmission sprocket 41 to 43 while it is not stagnant, contacts the smallest diameter portion 58c and the tapered portion 58b. Consequently, the stagnant part C1 of the chain C is guided by the guide roller 53a of the alignment guide 50 to reach the alignment hole 51 as aligned, resolving the stagnancy and preventing the stagnant part C1 from being caught in the drive sprocket 32 without resolving the stagnancy C1. In addition, since the chain C, which contacts the guide roller 53a while it is not stagnant, contacts the smallest diameter portion 58c and tapered portion 58b of the guide roller 53a, the chain C curves less than when it contacts the large diameter portion 58a without the smallest diameter portion 58c and the tapered portion 58b and the friction applied from the guide roller 53a to the chain C is thus reduced and the operating performance of the chain C is improved.

The guide roller 53a constitutes a guide part of the alignment guide 50, and the chain C, which is wound around the transmission sprocket 41, 42 and the transmission sprocket 43 while the chain C is not stagnant, contacts the smallest diameter portion 58c and the tapered portion 58b which constitute the small diameter portion 58b, 58c, so that rotation of the guide roller 53a further smoothens the guidance to align the stagnant part C1 and accelerates resolution of the stagnant part C1. In addition, the friction applied from the small diameter portion 58b, 58c to the chain C wound around a lower speed transmission sprocket 41 to 43 while the chain C is not stagnant is reduced so that the operating performance of the bicycle B at a low speed gear position is improved.

Since the guide surface 59 of the inner guide 52 of the alignment guide 50 has the largest projection 59c and the transitional projection 59b projecting toward the smallest diameter portion 58c and the tapered portion 58b, in order to maintain the width D of the alignment hole 51 in the direction of outward or inward movement of the chain C almost constant at any axial position, due to the projections 59c and 59b, the width D of the alignment hole 51 with the presence of the smallest diameter portion 58c and tapered portion 58b is almost equal to the width D of the alignment hole 51 defined by the large diameter portion 58a and the basic portion 59a, a portion other than the projections 59a and 59c of the guide surface 59. Therefore, alignment properly takes place in the smallest diameter portion 58c and tapered portion 58b. As a consequence, the friction from the guide roller 53a is reduced and proper alignment by the alignment guide 50 is ensured.

Since the limiting member 65, which restricts disengagement of the chain C from the guide pulley 82, is located between the guide pulley 82 and an active sprocket, on the wind-out side of the guide pulley 82 rotating in the normal rotation direction A, outwardly from a tangent line common to the guide pulley 82 and the active sprocket in the radial direction of the guide pulley 82, if a torsion occurs in the chain C due to a large axial movement of the guide pulley upon a gear shift operation when the transmission sprockets 41 to 47 are not rotating normally, more specifically when the bicycle B is being operated backward, namely the transmission sprockets 41 to 47 are rotating in the reverse direction or when the bicycle is stationary or the transmission sprockets 41 to 47 are at a stop, the friction between links of the chain C increases. If, because of the torsion, it becomes difficult for the chain C to sag along the guide pulley 82 and the chain C disengages from the guide pulley 82, the limiting member 65 contacts the chain C to alleviate the degree of disengagement of the chain C so that the operating performance of the chain C on the guide pulley 82 is improved.

Since the limiting member 65 lies between the rotational centerline L1 and the rotational centerline L3, in a position to overlap the transmission sprockets 41 to 47 when viewed sideways and is located in the space between the rotational centerlines L1 and L2, the distance between the crankshaft 12 and the transmission sprockets 41 to 47 need not be increased due to the presence of the limiting member 65. As a consequence, it is possible to provide the limiting member 65 while keeping the compactness of the transmission 1

Since the limiting member 65 is molded integrally with the alignment guide 50, the transmission T provided with the limiting member 65 is obtained without an increase in the number of components. Since the limiting member 65 uses the alignment guide 50 and is separate from the holder H supporting the guide pulley 82, the member which moves axially together with the guide pulley 82 upon gear shift operation is lighter than when the limiting member 65 is integral with the holder H, which allows quicker movement of the guide pulley 82 and improves the gear shift operability, namely the ease and reliability of gear shift.

Since the outer circumferential surface 94 of the tension pulley 92, which is to contact the chain C, consists of a surface which enables the chain C to slide axially and the chain C axially moves across an extensive area in the circumferential direction of the tension pulley 92 during axial movement of the tension pulley 92 upon a gear shift operation, the torsion in the chain C decreases and the friction between links Ca of the chain C decreases as well. Therefore, the chain C is easy to sag along the outer circumferential surface 94 of the tension pulley 92. Consequently, the chain C smoothly operates on the tension pulley 92 and the operating performance of the chain C is improved. In addition, since the operating performance of the chain C that operates toward the guide pulley 82 is improved, the gear shift operability is improved.

Since the transmission case 20 is located between the front wheel Wf and rear wheel Wr of the bicycle B and in the transmission T, located in the center of the bicycle B, the drive sprocket 32 and the transmission sprocket cluster 40 are adjacent to each other, the torsion in the chain C which occurs upon a gear shift operation tends to be considerable. However, the tension pulley 92 substantially reduces the torsion and therefore the chain C smoothly operates on the tension pulley 92. As a consequence, the operating performance of the chain C is improved in the transmission T located in the center of the bicycle B.

A partially modified version of the abovementioned embodiment is explained below, focusing on modifications.

The first guide may be not be a roller but may be a member that cannot rotate. The second guide may consist of a roller. The retreated portion may be provided in the inner guide and located inside the chain C.

The limiting member may prevent the chain C from disengaging from the guide pulley.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bicycle transmission comprising:
a drive sprocket rotated by a crankshaft;
a transmission sprocket cluster disposed in the axial direction and composed of a plurality of transmission sprockets having distinct outside diameters;
a chain wound around the drive sprocket and the transmission sprockets; and
a shift mechanism for shifting the chain among the transmission sprocket cluster according to a gear shift operation; and
an alignment guide being located between the drive sprocket and the transmission sprocket cluster to align a stagnant part of the chain;
wherein the alignment guide consists of a guide part with a guide surface for guiding the stagnant part of the chain in a way to align the chain;
the guide surface, in the axial direction, being provided with a basic portion located on the side of the transmission sprocket with the smallest outside diameter, and a retreated portion which is located on the side of the transmission sprocket with the largest outside diameter and more retreated inside or outside the chain than the basic portion; and
the chain contacts the retreated portion while the chain is not stagnant.

2. The bicycle transmission according to claim 1, wherein the guide part is a guide roller having an outer circumferential surface which constitutes the guide surface and the retreated portion is a small diameter portion with a diameter smaller than the basic portion and the chain wound around the transmission sprocket with the largest outside diameter contacts the small diameter portion while the chain is not stagnant.

3. The bicycle transmission according to claim 1, wherein the alignment guide includes a first guide as the guide part and a second guide having a second guide surface for forming an alignment hole through which the chain passes, in conjunction with a first guide surface as the guide surface of the first guide; and
the second guide surface has a projection projecting toward the retreated portion in order to maintain the width of the alignment hole in the direction of inward or outward movement of the chain almost constant at any axial position.

4. The bicycle transmission according to claim 2, wherein the alignment guide includes a first guide as the guide part and a second guide having a second guide surface for forming an alignment hole through which the chain passes, in conjunction with a first guide surface as the guide surface of the first guide; and
the second guide surface has a projection projecting toward the retreated portion in order to maintain the width of the alignment hole in the direction of inward or outward movement of the chain almost constant at any axial position.

5. The bicycle transmission according to claim 1, and further including side guides formed on each side of the alignment guide.

6. The bicycle transmission according to claim 5, wherein a limiter and a first side guide are integrally formed relative to each other and positioned on a first side of said alignment guide and the second side guide is displaced relative thereto and is positioned on a second side of said alignment guide.

7. The bicycle transmission according to claim 6, wherein the second side is secured to a transmission case wherein the alignment guide is fixed to the transmission case.

8. The bicycle transmission according to claim 2, wherein the guide roller is tapered from small diameter portion to the largest outside diameter portion to accommodate said chain as it is shifted from a largest transmission sprocket to a smallest transmission sprocket.

9. A bicycle transmission comprising:
a drive sprocket rotated by a crankshaft;
a transmission sprocket cluster including a plurality of transmission sprockets disposed in the axial direction; and
a shift mechanism for shifting the chain among the transmission sprocket cluster according to a gear shift operation;
said shift mechanism including a guide pulley around which the chain is wound, said guide pulley being moving axially for guiding the chain wound around one active sprocket selected from among the transmission sprocket cluster; and
a limiting member for the bicycle transmission, said limiting member restricting disengagement of the chain from the guide pulley;
said limiting member being located between the guide pulley and the active sprocket, outward in the radial direction of the guide pulley.

10. The bicycle transmission according to claim 9, wherein the limiting member is located between a rotational centerline of the crankshaft and a rotational centerline of the transmission sprockets in a position to overlap the transmission sprockets when viewed sideways.

11. The bicycle transmission according to claim 10, and further including an alignment guide located between the drive sprocket and the transmission sprocket cluster for aligning a stagnant part of the chain, said limiting member being molded integrally with the alignment guide.

12. The bicycle transmission according to claim 9, wherein said limiter is positioned to overlap the transmission sprocket and extends from an inner guide towards the transmission sprocket.

13. The bicycle transmission according to claim 12, wherein said limiter includes a tip having as many grooves as teeth of the transmission sprocket to pass individually.

14. The bicycle transmission according to claim 12, wherein said limiter suppresses vibration of the chain while allowing the chain to pass through an alignment hole to permit smooth operation of the chain.

15. A bicycle transmission comprising:
a drive sprocket rotated by a crankshaft;
a transmission sprocket cluster including a plurality of transmission sprockets disposed in the axial direction; and
a shift mechanism for shifting the chain among the transmission sprocket cluster according to gear shift operation;
said shift mechanism includes a guide pulley around which the chain is wound and a tension pulley for tensioning the chain;
said guide pulley moving axially together with the tension pulley upon a gear shift operation for guiding the chain wound around one active sprocket selected from among the transmission sprocket cluster; and
a part of the tension pulley to contact the chain consists of a surface on which the chain can slide axially.

16. The bicycle transmission according to claim 15, and further including a transmission case for supporting the crankshaft and the transmission sprocket cluster, said transmission case being located between the front wheel and rear wheel of the bicycle

17. The bicycle transmission according to claim 15, and further including a first arm located on one side of the tension pulley and a second arm located on a second side of the tension pulley and a support part for rotatably supporting the tension pulley relative to the first and second arms.

18. The bicycle transmission according to claim 17, wherein said support part is a bolt for securing the first and second arms relative to each other and further including a bearing for rotatably supporting the tension pulley relative to the bolt.

19. The bicycle transmission according to claim 15, and further including a tension spring for biasing the first and second arms in a clockwise direction.

20. The bicycle transmission according to claim 15, and further including soundproof sheets for attenuating noise of collision between the chain and the transmission sprockets.
